(19) United States
(12) Patent Application Publication
(10) Pub. No.: US 2016/0098754 A1
(43) Pub. Date: Apr. 7, 2016

(54) SYSTEMS AND METHODS FOR OBTAINING INFORMATION AND APPROVAL TO MARKET TO A CERTAIN PERSON

(71) Applicant: Soniram, LLC, Louisville, KY (US)

(72) Inventor: Robert M. Marino, Louisville, KY (US)

(21) Appl. No.: 14/877,374

(22) Filed: Oct. 7, 2015

Related U.S. Application Data
(60) Provisional application No. 62/060,969, filed on Oct. 7, 2014.
(60) Provisional application No. 62/169,982, filed on Jun. 2, 2015.

(51) Int. Cl. G06Q 30/02

(52) U.S. Cl. CPC G06Q 30/0258; G06Q 30/0271

(57) ABSTRACT

A method and a corresponding system for obtaining information and approval to market to a certain person, include: storing in a database, by a platform server, at least an identifier; and sending an incentive to the certain person in response to receiving verification from a communication device of the certain person using the identifier and approval for receiving marketing from a merchant. The certain person can be the recipient of a gift or a card, or a customer receiving a self-bought package. The identifier can be a unique identifier such that the incentive can include a custom message or other personalization. The recipient of a gift or a card can send a “thank you” and/or a custom message to the respective gift giver or the card sender. The platform server does not share contact information between the giver and the recipient.

### CROSS-REFERENCE TO RELATED APPLICATIONS

This application claims the benefit of U.S. Provisional Patent Application No. 62/060,969, filed Oct. 7, 2014, and U.S. Provisional Patent Application No. 62/169,982, filed Jun. 2, 2015, the disclosures of which are incorporated herein by reference.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

This invention relates to systems and methods for obtaining information and approval to market to certain persons, including recipients of gift products, self-buy packages, greeting cards, thank you cards, invitations, and other stationary. The systems and methods may be referred to herein as “Thank You Back” or “TYB,” or “Retentage,” or “Sound Affections” or “SA.”

2. Background Art

Merchants want to expand their customer list and desire help acquiring new customers. Gift orders comprise 25% of consumer product sales. However, standard marketing to gift recipients includes box inserts offering incentives to “sign up.” Such standard marketing has a very low response rate.

Additionally, while it is possible to send greeting cards with packages purchased on line, the implementation involves generic, pre-printed cards that are impersonal, or printing greeting cards at each shipping station, which has a low rate of adoption.

### BRIEF SUMMARY OF THE INVENTION

According to an aspect of the invention, a system for obtaining information and approval to market to a recipient of a gift includes a database and a platform server in communication with the database, the platform server including a processor operably connected to memory, and input/output devices. The processor executes software instructions stored in the memory for causing the platform server to: store in the database a unique identifier and order information including contact information of a giver and contact information of the recipient; and send a thank you message to a gift giver communication device in response to receiving a request from a gift recipient communication device, verification from the gift recipient communication device using the unique identifier, and approval from the gift recipient communication device for receiving marketing from a merchant.

In one implementation, the platform server associates a custom message to the recipient with the unique identifier in response to receiving a selection from the gift giver communication device of an option to create the custom message, and delivers the custom message to the gift recipient communication device in response to the verification.

In another implementation, the gift includes an incentive for the recipient to thank the giver, and wherein the platform server associates the incentive with the unique identifier, and releases and sends the incentive to the giver with the thank you message, so that release of the incentive is controlled by the recipient.

In yet another implementation, the platform server manages generation of a physical thank you card with a custom message to be sent by mail to the giver in response to a request from the gift recipient communication device, or purchase and sending of a gift card by the recipient to the giver in response to a request from the gift recipient communication device.

Verification from the gift recipient communication device using the unique identifier may utilize a URL hosted by the platform server. The unique identifier may be included on an internal packing slip of the gift, or on a shipping label of the gift.

According to another aspect of the invention, a method for obtaining information and approval to market to a recipient of a gift includes: storing in a database, by a platform server, a unique identifier, order information, contact information of a giver, and contact information of the recipient; and sending, by the platform server, a thank you message to a gift giver communication device in response to receiving a request from a gift recipient communication device, verification from the gift recipient communication device using the unique identifier, and approval from the gift recipient communication device for receiving marketing from a merchant.

One implementation includes associating, by the platform server, a custom message to the recipient with the unique identifier in response to receiving a selection from the gift giver communication device of an option to create the custom message, and delivering the custom message to the gift recipient communication device in response to the verification. The method may include associating, by the platform server, the custom message with the unique identifier before shipment of the gift or during transit of the gift.

Another implementation includes sending, by the platform server, a reassurance message to the gift recipient communication device that contact information of the recipient will not be shared with the giver, and receiving acceptance of terms of service from the gift recipient communication device before sending the thank you message.

Acceptance of the terms of service may include receiving from the gift recipient communication device a sign on through social media or creating a user name and password.

The method may include managing, by the platform server, generation of a physical thank you card with a custom message to be sent by mail to the giver in response to a request from the gift recipient communication device, or purchase and sending of a gift card by the recipient to the giver in response to a request from the gift recipient communication device.

According to another aspect of the invention, a system for obtaining information and approval to market to a recipient of a card includes a database and a platform server in communication with the database, the platform server including a processor operably connected to memory, and input/output devices. The processor executes software instructions stored in the memory for causing the platform server to: store in the database a unique identifier, contact information of a card sender, and a custom message to a card recipient from a card sender communication device; and send the custom message to a card recipient communication device in response to receiving verification from the card recipient communication device using the unique identifier, and approval from the card recipient communication device for receiving marketing from a merchant.

In one implementation, the platform server further sends a custom reply to the card sender communication device in response to receiving the custom reply from the card recipient communication device. The card may be an invitation, and the custom reply may be a reply to the invitation. In this case, the invitation may include questions, and the custom reply may include answers to the questions. Additionally, the platform server may create a spreadsheet sortable by who is confirmed, who is not coming, and who has not responded.

According to yet another aspect of the invention, a method for obtaining information and approval to market to a recipient of a card includes: storing in a database, by a platform server, a unique identifier, contact information of a card sender, and a custom message to a card recipient from a card sender communication device; and sending, by the platform server, the custom message to a card recipient communication device in response to receiving verification from the card recipient communication device using the unique identifier, and approval from the card recipient communication device for receiving marketing from a merchant.

One implementation may further include sending, by the platform server, a reassurance message to the card recipient communication device that contact information of the card recipient will not be shared with the card sender, and receiving acceptance of terms of service from the card recipient communication device before sending the custom message. Acceptance of the terms of service may then include receiving from the card recipient communication device a sign on through social media or creating a user name and password.

According to yet another aspect of the invention, a system for obtaining information and approval to market to a customer receiving a package includes a database and a platform server in communication with the database, the platform server including a processor operably connected to memory, and input/output devices. The processor executes software instructions stored in the memory for causing the platform server to: store in the database an identifier and a link to a URL containing an incentive from a merchant; and send the link to a customer communication device in response to receiving verification from the customer communication device using the identifier, and approval from the customer communication device for receiving marketing from the merchant. The identifier may be a unique identifier, identification of the customer may be associated with the unique identifier in the database, and the incentive from the merchant may be personalized for the customer.

According to still a further aspect of the invention, a method for obtaining information and approval to market to a customer receiving a package includes: storing in a database, by a platform server, an identifier and a link to a URL containing an incentive from a merchant; and sending, by the platform server, the link to a customer communication device in response to receiving verification from the customer communication device using the identifier, and approval from the customer communication device for receiving marketing from the merchant. The identifier may be a unique identifier and identification of the customer may be associated with the unique identifier in the database. The method may then further include personalizing the incentive from the merchant for the customer.

### BRIEF DESCRIPTION OF THE DRAWINGS

FIG. 1 is a functional block diagram of an exemplary embodiment of a system according to the invention.

FIG. 2 is a call flow diagram of an exemplary embodiment of a method according to the invention.

FIG. 3 is a schematic representation of an exemplary shipping label according to an embodiment of the invention.

FIG. 4 is a schematic representation of an exemplary packing slip according to an embodiment of the invention.

FIG. 5 is an exemplary screen shot of a screen that the recipient may see on the gift recipient communication device upon contacting the platform server.

FIG. 6 is an exemplary screen shot of a screen that the recipient may see on the gift recipient communication device where the platform server offers to the recipient the options of sending by mail of a physical thank you card or a gift.

FIG. 7 is a functional block diagram of another exemplary embodiment of a system according to the invention.

FIG. 8 is a functional block diagram of another exemplary embodiment of a system according to the invention.

FIG. 9 is a call flow diagram showing exemplary interaction between the various computing and communicating machines and entities of FIG. 8.

FIG. 10 is a functional block diagram of another exemplary embodiment of a system according to the invention.

FIG. 11 is a call flow diagram showing exemplary interaction between the various computing and communicating machines and entities of FIG. 10.

### DETAILED DESCRIPTION OF EXEMPLARY EMBODIMENTS OF THE INVENTION

The details of one or more embodiments of the presently-disclosed subject matter are set forth in this document. Modifications to embodiments described herein, and other embodiments, will be evident to those of ordinary skill in the art after a study of the information provided herein. The information provided herein, and particularly the specific details of the described exemplary embodiments, is provided primarily for clearness of understanding and no unnecessary limitations are to be understood therefrom. In case of conflict, the specification of this document, including definitions, will control.

While the terms used herein are believed to be well understood by one of ordinary skill in the art, definitions are set forth herein to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims.

The term “processor” is used herein to describe one or more microprocessors, microcontrollers, central processing units, Digital Signal Processors (DSPs), Field-Programmable Gate Arrays (FPGAs), Application-Specific Integrated Circuits (ASICs), or the like for executing instructions stored in memory.

The term “memory” is used herein to describe physical devices (computer readable media) used to store programs (sequences of instructions) or data (e.g. program state information) on a non-transient basis for use in a computer or other digital electronic device, including primary memory used for the information in physical systems which are fast (i.e. RAM), and secondary memory, which are physical devices for program and data storage which are slow to access but offer higher memory capacity. Traditional secondary memory includes tape, magnetic disks and optical discs (CD-ROM and DVD-ROM). The term “memory” is often, but not always, associated with addressable semiconductor memory, i.e. integrated circuits consisting of silicon-based transistors, and used for example as primary memory but also other purposes in computers and other digital electronic devices. Semiconductor memory includes both volatile and non-volatile memory. Examples of non-volatile memory include flash memory (sometimes used as secondary, sometimes primary computer memory) and ROM/PROM/EPROM/EEPROM memory. Examples of volatile memory include dynamic RAM memory, DRAM, and static RAM memory, SRAM.

The term “URL” stands for uniform resource locator, which is a specific character string that constitutes a reference to a resource. Most web browsers display the URL of a web page above the page in an address bar.

The term “QR code” is abbreviated from Quick Response Code, and is the trademark for a type of matrix barcode (or two-dimensional barcode) first designed for the automotive industry in Japan. A barcode is a machine-readable optical label that contains information about the item to which it is attached.

The term “API” stands for application programming interface. An API is a software intermediary that makes it possible for application programs to interact with each other and share data.

The term “communication device” means a personal computer, a tablet computer, a smart phone, or any other communication device capable of communicating with a server through a communication network.

### 1. First Embodiment

### Thank You Back

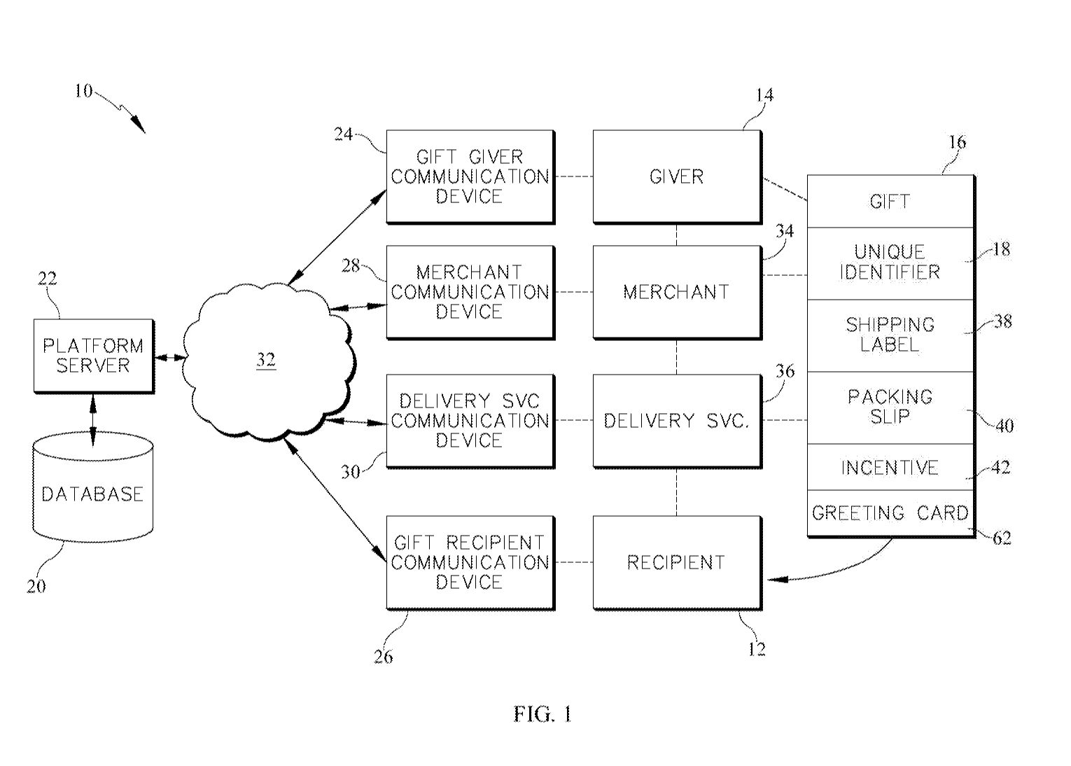

FIG. 1 shows an exemplary embodiment of a system 10 for obtaining information and approval to market to a recipient 12 of a gift 16 (from a giver 14), the gift 16 including a unique identifier 18. The system 10 includes a database 20, a platform server 22, a gift giver communication device 24, and a gift recipient communication device 26. The system 10 also includes a merchant communication device 28 and a delivery service communication device 30.

A communication network 32 allows communication between the platform server 22, the gift giver communication device 24, the gift recipient communication device 26, the merchant communication device 28, and the delivery service communication device 30. The communication network 32 may be the Internet, or any other appropriate network or networks for communicating information between the database 20, the platform server 22, and the communication devices 24, 26, 28, 30 (i.e., computing and communicating machines and entities) discussed herein.

Also shown in FIG. 1 are a merchant 34 and a delivery service 36, as well as a shipping label 38, a packing slip 40, and an incentive identifier 42. The merchant 34 and the delivery service 36 are entities, similar to the recipient 12 and the giver 14. The shipping label 38, the packing slip 40, and incentive identifier 42 are associated with the gift 16.

The platform server 22 is in communication with the database 20. The platform server 22 includes at least one processor operably connected to memory and input/output devices (not shown). The platform server 22 executes software, as discussed below. The platform server 22 may include more than one physical server and may also utilize “cloud hosting” or “managed hosting” (many servers hosted by third parties).

The gift giver communication device 24 is in communication with the platform server 22 through the communication network 32. The gift giver communication device 24 may be a personal computer, a tablet computer, a smart phone, or any other communication device capable of communicating with the platform server 22 through the communication network 32. The communication network 32 may be the Internet, or any other appropriate network or networks for communicating information between the computing and communicating machines discussed herein.

The gift recipient communication device 26 is in communication with the platform server 22 through the communication network 32. The gift recipient communication device 26 may also be a personal computer, a tablet computer, a smart phone, or any other communication device capable of communicating with the platform server 22 through the communication network 32.

The merchant communication device 28 of this exemplary embodiment may be a computer server or the like that hosts a website through which the merchant 34 offers and sells products (i.e., an online merchant), or may be a personal computer, a tablet computer, a smart phone, or any other communication device with which a brick-and-mortar retailer can communicate with the platform server 22 through the communication network 32. Examples of online merchants of this exemplary embodiment include retailers such as Amazon.com and 1-800-Flowers.

The delivery service communication device 30 of this exemplary embodiment is computer server or the like hosting a website of the delivery service 36. Examples of delivery services of this exemplary embodiment include Federal Express and United Parcel Service (UPS). The delivery service communication device 30 is configured to deliver updates (e.g., email messages) to the gift giver communication device 14 showing when the gift 16 is shipped and when the gift 16 is delivered. These delivery service updates offer additional opportunities for the giver 14 to record and assign a custom message (discussed below) to the recipient 12.

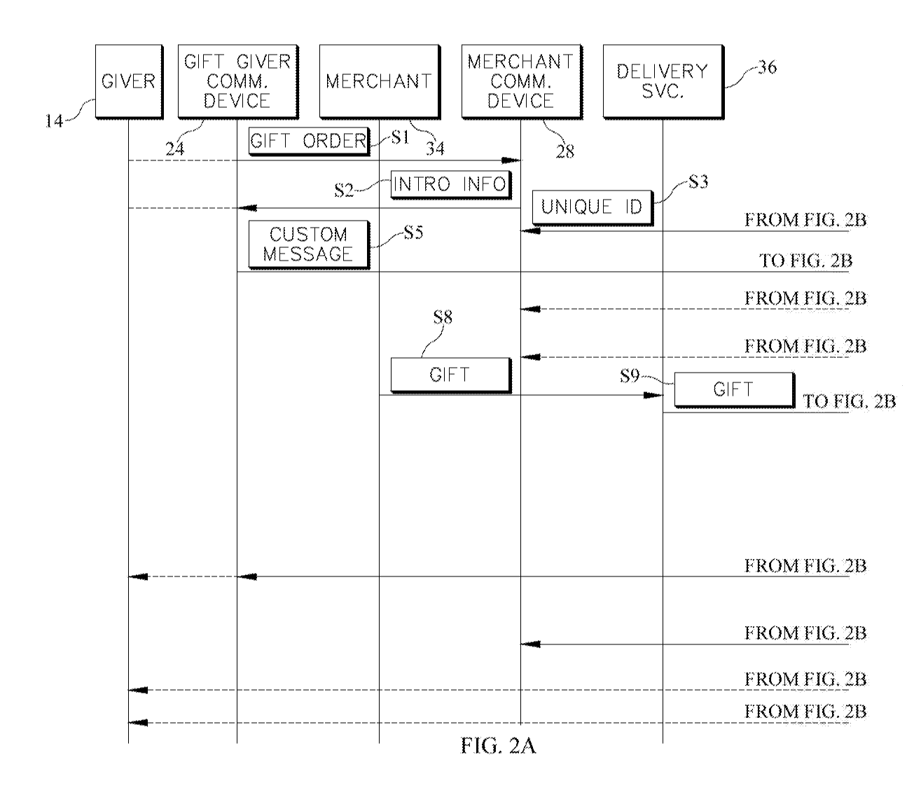

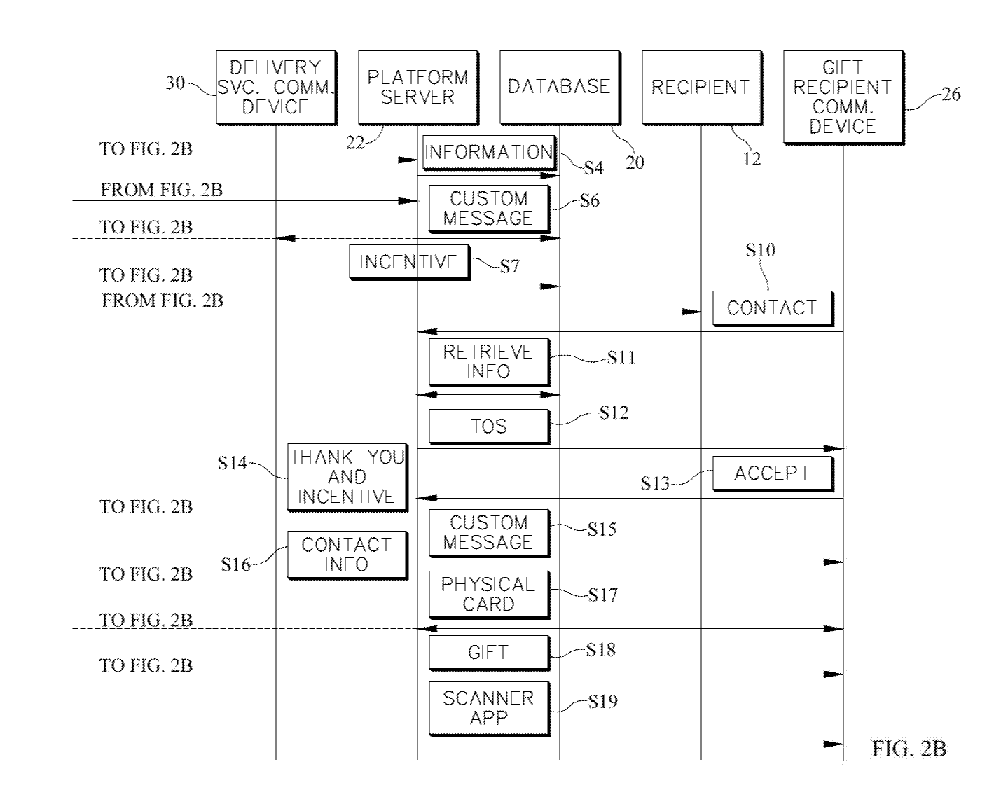

FIG. 2 is a chart showing exemplary interaction between the various computing and communicating machines and entities described herein, which are labeled in accordance with the labels shown in FIG. 1 and described in connection therewith.

In step S1, the giver 14 places an order with the merchant 34 for the gift 16 for the recipient 12. For example, the step could be the giver 14 ordering flowers to be delivered to the recipient 12 using a florist's web site or at a brick-and-mortar store. FIG. 2 shows the giver 14 placing the gift order using the gift giver communication device 24 in communication with the merchant communication device 28. In the case of brick-and-mortar store, the giver 14 can be handed one half of a preprinted serialized ticket. The giver half contains info they need to log on with the gift giver communication device 24 and make a custom message for the recipient 12 (discussed below). The other half of the ticket is the recipient half. It is placed on the box for the recipient 12 to see and it carries the necessary log on info for the recipient 12 to log on with the recipient communication device 26. As used herein, the gift giver communication device 24 could include a combination of communication devices (e.g., personal computer, a tablet computer, a smart phone, or any other communication device capable of communicating with the platform server 22 through the communication network 32), such that a giver 14 could place an order using one device (e.g., a computer) and could make and assign a custom message (discussed below) to the recipient using another device (e.g., a smart phone).

In step S2, the gift giver 14 receives introduction information from the merchant 34 (or, as shown, the gift giver communication device 24 receives introduction from the merchant communication device 28) after the order is placed. The gift giving situation is apparent when the name and address in the billing fields are different than the name and address in the ship to fields, or in the case of brick-and-mortar store, by the merchant asking is this a gift. The introduction information includes information introducing the features and benefits of participating in the program (i.e., the system and method for communicating a “thank you” message from a recipient to a giver of a gift), including the ability to send a custom message to the recipient 12, as described in more detail below. The introduction information can be received by the gift giver 14 during the gift order process. Alternately, the introduction information can be received by the gift giver 14 in an order confirmation email. In either event, the introduction information includes reassurance that the contact information of the giver 14 will not be shared with the recipient 12. The gift giver 14 also receives a unique URL, a unique code/phone number, or a non-unique URL or non-unique code/phone number that can be used with an order number, a package number (i.e. tracking number) on a shipping label, or a number generated by the platform server 22, that the gift giver 14 can use to access the platform server 22 to create a custom message (discussed below). In the case of a unique URL, such unique URLs can be prepackaged in bulk before a busy holiday period and sent to the merchant communication device 28 in advance. The merchant communication device 28 can then provide the unique URL to the giver 14 during the transaction without waiting for the URL to be created, and the order information can later be sent by the merchant communication device 28 to the platform server 22 via the API of the platform server (discussed below).

In step S3, the merchant communication device 28 and the platform server 22 communicate to establish a unique identifier for the gift order, and to communicate the order information, including contact information (i.e., a name) of the giver 14 and contact information (i.e., a name) of the recipient 12. The unique identifier 18 can be a unique URL (e.g., (www.platformserver/uniqueidentifier)), a QR code or similar, or a code/phone number (e.g., “text this code to this (xxx) XXX-XXXX”). The unique identifier can appear on the packing slip 40 and/or the shipping label 38.

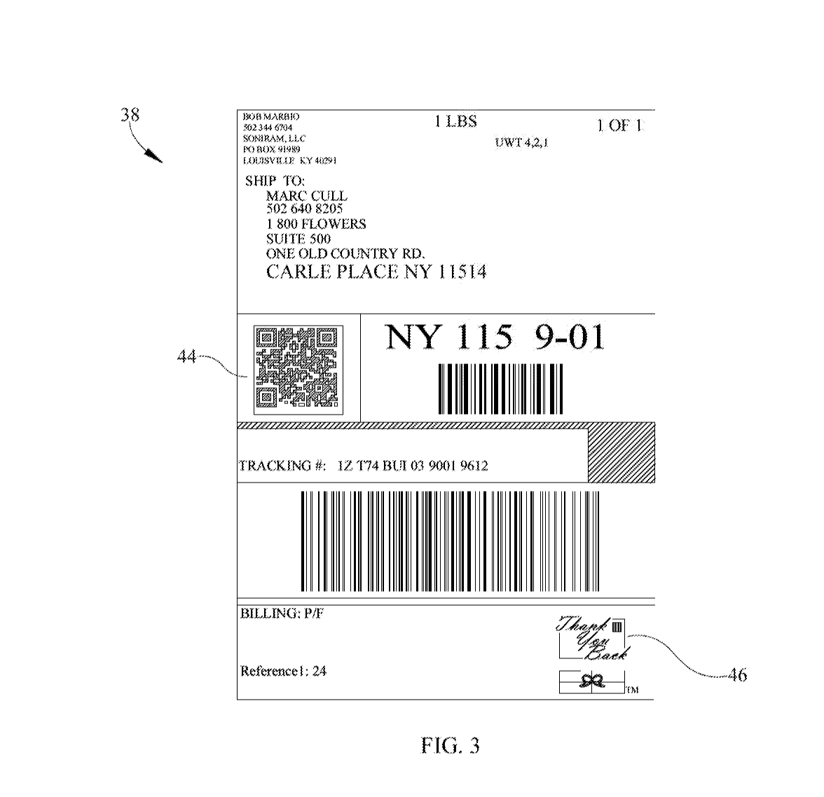

FIG. 3 is a schematic representation of an exemplary shipping label 38 according to an embodiment of the invention. The exemplary shipping label 38 includes a QR code 44 that encodes a unique URL as the unique identifier. The exemplary shipping label 38 also includes indicia 46 indicating that the package is in the system 10.

In step S4, the platform server 22 stores order information with the corresponding unique identifier in the database 20. The platform server 22 has an application programming interface (API) to receive and pass this information.

In optional step S5, the giver 14 may select, using the gift giver communication device 24 in communication with the platform server 22, from several options to create a custom message to the recipient 12. The custom message may be made before shipment of the gift or while the gift is in transit. The options include video, text, voice, and picture with caption. As noted above, the gift giver communication 24 device may be a personal computer, a tablet computer, a smart phone, or any other communication device capable of communicating with the platform server 22 through the communication network 32. The giver 14 can also be informed at this point that they can help select the types of things that the recipient and he/she may wish to consider buying in the future, thus allowing the merchant 34 to have more targeted and successful offers.

In step S6, the platform server 22 associates the custom message to the unique identifier and saves the custom message to the database 20. It should be noted that the giver 14 does not need to create a custom message to the recipient for proper operation of the system and method of the invention because a gift context is known when the giver 14 and the recipient 12 are two different people and this is further evidenced if the addresses of each are different. Whether the giver 14 creates a custom message or not, a call to action for the recipient 12 will be generated and printed on the packing slip 40 created by the merchant 34, enticing the recipient 12 to send a message of thanks. The message on the packing slip 40 is optimized to enhance the motivation of the recipient 12 to accept the terms of service (TOS) (described below). This can be done by leading with a “listen to the gift giver's message” when before shipment the gift giver created a voice message, or “read the message” when before shipment the giver created a message. The integration of the delivery service 36 (such as FedEx and UPS) and the delivery service communication device 30 allows such customization of the call to action message on the shipping label 38. When no message is created before shipment, the message can be “go here to thank the giver.”

In optional step S7, the platform server 22 determines an incentive to offer to the recipient 12, associates the incentive with the unique identifier, and saves the custom message to the database 20. An algorithm is used to customize the incentive the recipient will receive in addition to being biased or strictly obedient to preset offers defined by the merchant 34. In other words, the algorithm is for assessing and setting the amount of incentive required to optimize acceptance of terms of service (TOS) by the recipient 12 without being overly promotional, thereby conserving as much revenue as possible. For example, if the recipient has already accepted the TOS (described below) in the past with previous orders; even orders placed with other merchants, and the recipient's profile indicates they use the platform server 22 to thank the giver 14 just to be polite and require very little additional incentive beyond that, then the incentive back to the giver 14 can be lessened. Likewise, the magnitude of the offer presented to the recipient 12 can be manipulated based upon responses to incentives presented in previous order occasions. However, the merchant 34, using the merchant communication device 28, can override the algorithm for specifically dictated promotions. If the incentive is customized and it is desired to communicate the incentive to the recipient, the customized incentive is also transmitted to the merchant communication device 28 for printing on the packing slip 40. Otherwise, if the incentive is a preset offer defined by the merchant 34 or a customized but it is not desired to communicate the customized incentive to the recipient, the merchant 34 can print the packing slip 40 without communicating with the platform server 22. The packing slip 40 will ideally convey an inexact message about the actual incentives for the giver 14 but instead provide a message that peaks curiosity and will boldly state by use of the giver's name a call to action for the recipient 12 to send a message of thanks.

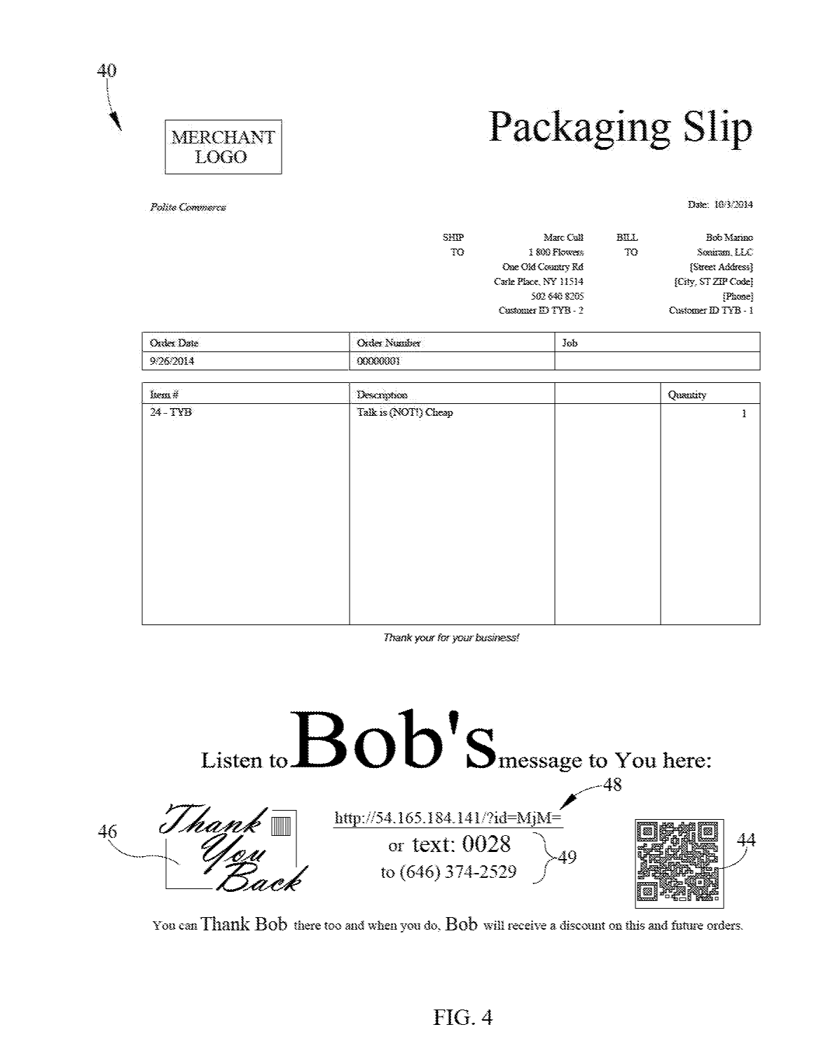

FIG. 4 is a schematic representation of an exemplary packing slip 40 including a message that peaks curiosity and boldly states by use of the giver's name (e.g., “Bob”) a call to action for the recipient 12 to send a message of thanks, according to an embodiment of the invention. The exemplary packing slip 40 includes a QR code 44 that can be used to encode a URL as the unique identifier. The exemplary packing slip 40 also includes indicia 46 indicating that the package is in the system 10. The exemplary packing slip 40 also includes indicia 48 providing a URL and code/phone number 49 (e.g., “text this code to this (xxx) XXX-XXXX”) for a recipient 12 to use to contact the platform server 22 (discussed below). The code/text number 49 is the preferred method due to its ease.

The first possible encounter for a recipient 12 with the platform server 22 can be triggered by the indicia 46 (e.g., a logo) and other messaging on the shipping label 38 (see, e.g., FIG. 3). A more reliable first encounter for the recipient 12 with the platform server 22 will be triggered by an incentive message on the packing slip 40 the merchant 34 puts in a box with the gift 16 (see, e.g., FIG. 4). Ideally this incentive message is large and bold and mentions the giver 14 by name so as to catch the attention of the recipient 12. For example the packing slip may read, “Thank (giver name) for this gift and your thanks will give (giver name) cash back on this order at no cost to you.” The incentive could apply to the current order (monetary discount on goods or freight) so the giver 14 would get a credit back once the recipient 12 says thank you by accepting the TOS (described below) through the platform server 22, or the incentive could be for future orders (30% off of the next order).

In step S8, the gift 16, including the unique identifier 18, the shipping label 38, and the packing slip 40 (see FIG. 1), is transferred from the merchant 34 to the delivery service 36.

In step S9, the gift 16 is delivered by the delivery service 36 to the recipient 12.

In step S10, the recipient 12, using the gift recipient communication device 26 contacts the platform server 22 using the unique identifier 18 included with the gift 16. This step is also a request by the gift recipient communication device 26 to send a thank you message to the gift giver communication device 24 and, if an incentive was associated with the unique identifier, to release and send the incentive to the gift giver 14 (via communication with the gift giver communication device 24). Thus placing the trigger to release the incentive in the hands of the gift recipient 12 (i.e., the reverse of other in-box marketing schemes). The desire to help the gift giver 14 save money adds to the motivation that already exists to say thank you. The thank you message is video, text, voice, picture with caption, or any combination thereof.

In step S11, the platform server 22 retrieves information associated with the unique identifier 18 from the database 20. The information retrieved includes the contact information of the recipient 12, which the platform server 22 uses to determine if the recipient has accepted the TOS in the past with previous orders. In a preferred embodiment, the recipient 12 texts in to get the link, and by doing so the platform server 22 automatically captures the cell phone number of the recipient 12 as contact info.

If the recipient 12 has not previously accepted the TOS or at s subsequent time from last acceptance opted out, step S12 is sending the TOS to the gift recipient communication device 26. This step includes reassurance to the recipient 12 that the contact information of the recipient 12 will not be shared with the giver 14. Then step S13 is sending an indication of acceptance of the TOS from the gift recipient communication device 26 to the platform server 22. Acceptance of the TOS can include receiving from the gift recipient communication device 26 a sign on through social media or creating a user name and a password. Additional contact information, such as an email address, and a phone number may also be part of acceptance of the TOS. Acceptance of the TOS also includes approval for receiving marketing

Upon acceptance of the TOS, or, if the TOS was previously accepted, step S14 is sending the thank you message and, if an incentive was associated with the unique identifier, releasing and sending the incentive to the gift giver 14 (via communication with the gift giver communication device 24).

If the giver 14 created a custom message to the recipient 12, then step S15 is delivering the custom message to the gift recipient communication device 26.

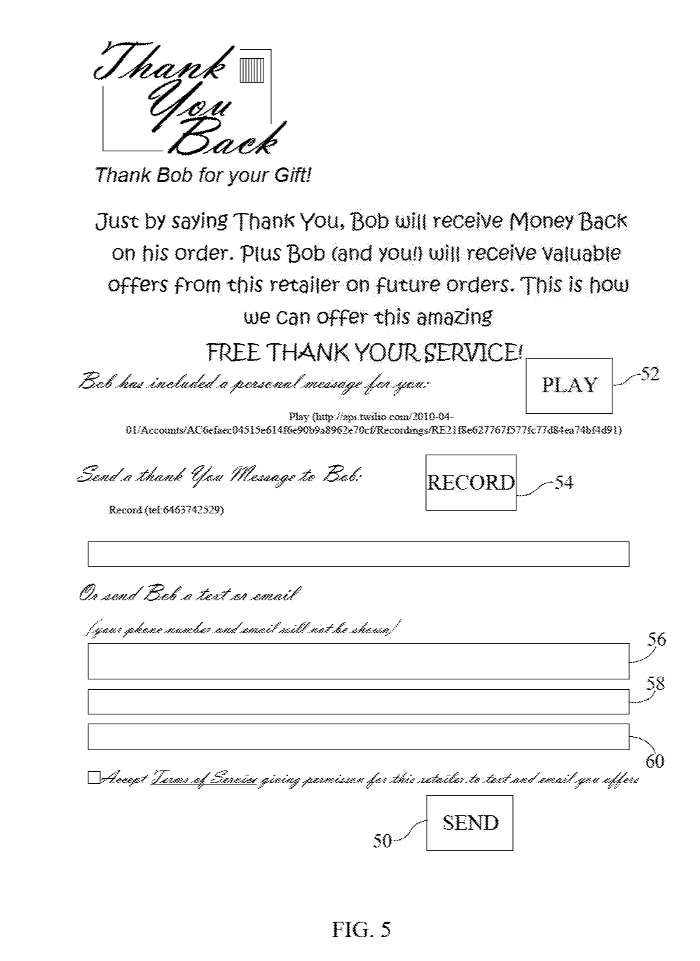

FIG. 5 is an exemplary screen shot of a screen that the recipient 12 may see on the gift recipient communication device 26 upon contacting the platform server 22 in step S10, including a button 50 for accepting the TOS, a button 52 for playing a custom message to the recipient 12, and a button 54 for recording a custom message to the giver 14. Also shown is a text field 56 for typing a message, a box 58 for the recipient 12 to enter their name, and a box 60 for the recipient 12 to enter their email address. A phone number of the recipient 12 is automatically captured as the recipient uses their phone to record a voice message.

Returning now to FIG. 2, step S16 is providing, by the platform server 22 to the merchant communication device 28, the contact information of the recipient 12 for use by the merchant 34 in marketing to the recipient 12. Thus, the merchant 34 increases its customer list and lowers acquisition costs for each recipient. Advantageously, the recipient 12 is provided with a fast and easy way to say thank you, is rewarded in knowing that they helped lower the price for the giver 14, and may also receive valuable offers. The giver 14 gets to make and send a personalized message with the gift 16, gets feedback from the recipient 12, and gets valuable discounts and offers when the recipient 12 thanks them.

Optionally, in step S17 the platform server 22 may offer to the recipient 12 and the recipient 12, using the gift recipient communication device 26, may request the platform server 22 to manage the generation and sending by mail of a physical thank you card with a custom message to the giver 14. The platform server 22 may offer the recipient 12 the opportunity to use the same video and/or text and/or voice recording as content for the card, or the opportunity to create new content can be offered. The voice and video options can be associated with the thank you card by use of a QR code printed on the card or a unique URL. Many times the shipping label 38 already includes the address of the gift giver 14. In this instance the giver's address becomes known to the recipient 12 and as a result the merchant 34 may elect to place a physical thank you card in the box for the gift recipient 12 to use to mail back to the gift giver 14. This card can be personalized with the same four forms of messages (video, audio, picture, text) by the recipient 12. In other instances the physical card can have an encrypted address bar code to keep the address of the gift giver 14 private.

In optional step S18, the platform server 22 may offer to the recipient 12, and the recipient 12, using the gift recipient communication device 26, may request the platform server 22 to manage the purchase and sending of a gift or gift card to the giver 14. On some occasions it is not practical for the platform server 22 to present the original merchant 34 to the recipient 12 for buying gift items (e.g., the merchant may not have a site and the gift giver bought the item from a store in another state). For occasions such as these, favored online sellers would be selected to be shown to the gift recipient at this point.

Optional steps S17 and S18 are performed after the platform server 22 has received acceptance of the TOS from the recipient 12, so as not to interfere with the primary purpose of getting the recipient 12 to agree to the TOS.

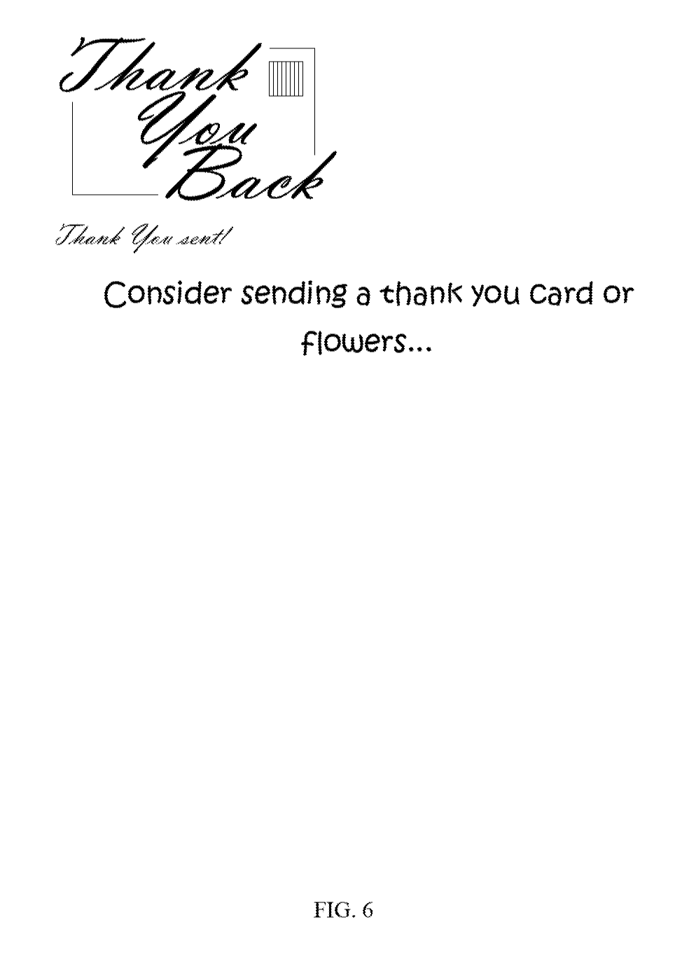

FIG. 6 is an exemplary screen shot of a screen that the recipient 12 may see on the gift recipient communication device 26 where the platform server 22 offers to the recipient 12 the options of sending by mail of a physical thank you card or a gift.

Returning again to FIG. 2, in optional step S19, the platform server 22 manages a transmission of a scanner application to the gift recipient communication device 26 to facilitate future communication. Once a recipient 12 tries the system 10, the various user interface screens they encounter can have posted links to scanner application for download, and FAQ (frequently asked questions) to show how the scanner can make future uses of the system 10 even easier. Following installation of the scanner application, the step S10 of the recipient 12 contacting the platform server 22 can include the recipient 12 using the gift recipient communication device 24 to scan the shipping label 38 or the packing slip 40 of the gift 16. If the shipping label 38 is scanned, since the shipping label 38 is on the outside of the shipping box of the gift 16 and, therefore, public, the platform server 22 may require the recipient to enter a code present on the internal packing slip 40 before the platform server 22 delivers a custom message from the giver 14 to the gift recipient communication device 26. Alternatively, the platform server 22 may require the recipient 12 to “log in” using a username and passcode. The platform server 22 may then compare the name and address of the recipient 12 and an identifier of the gift recipient communication device 26 (e.g., a smart phone ID) to the information associated with the username and passcode to verify the recipient 12 before delivering a custom message from the giver 14. The preferred path is to only allow the custom message from the giver 14 to be accessed from information contained on the internal packing slip 40. The external shipping label 38 is the preferred means for the gift recipient communication device 26 to contact the platform server 22 to request that a thank you message be sent to the gift giver communication device 24 because this action does not pose a security challenge as the giver 14 and recipient 12 cannot view to each other's contact info through the platform server 22. The platform server 22 can always be used to just say thanks without incentives to do so. It is noted that scanning a code (internal or external) is preferred only after the recipient 12 is already known and has accepted the TOS. That is because the act of scanning does not capture any contact info. The use of text or email is preferred before the recipient is known and accepts the TOS.

It is worth noting that the platform server 22 could be used to send incentives, from featured merchants (not necessarily limited to the merchant 34 that provided the gift 26), on any order. For instance, if the merchant 34 is a florist, a dried flower kit offer from a different florist could be associated with the order place with the merchant 34, whether the order was a gift or a self-buy order.

In a further extension of this embodiment, a pre-printed and serialized greeting card 62 (see FIG. 1) can be personalized by the gift giver 14 using the platform server 22. When the gift 16 is being ordered, the merchant 34 can offer, for an additional fee (or not if the selling price of the good in sufficiently high), to include the pre-printed and serialized greeting card 62 with the gift. Should the gift giver 14 choose to include such a pre-printed and serialized greeting card 62, the order information communicated between the merchant communication device 28 and the platform server 22 includes the serial number of the greeting card 62 to be included with the gift 16, such that the platform server 22 associates the custom message described in connection with step S5 with the pre-printed and serialized greeting card 62. The information on the pre-printed and serialized card then replaces the call to action information discussed above as being included on the shipping label 38 (FIG. 3) and/or the packaging slip 40 (FIG. 40). Advantageously, the gift giver 14 can personalize the pre-printed and serialized greeting card 62 without ever physically possessing the greeting card 62.

### 2. Second Embodiment

### Aggregator Model

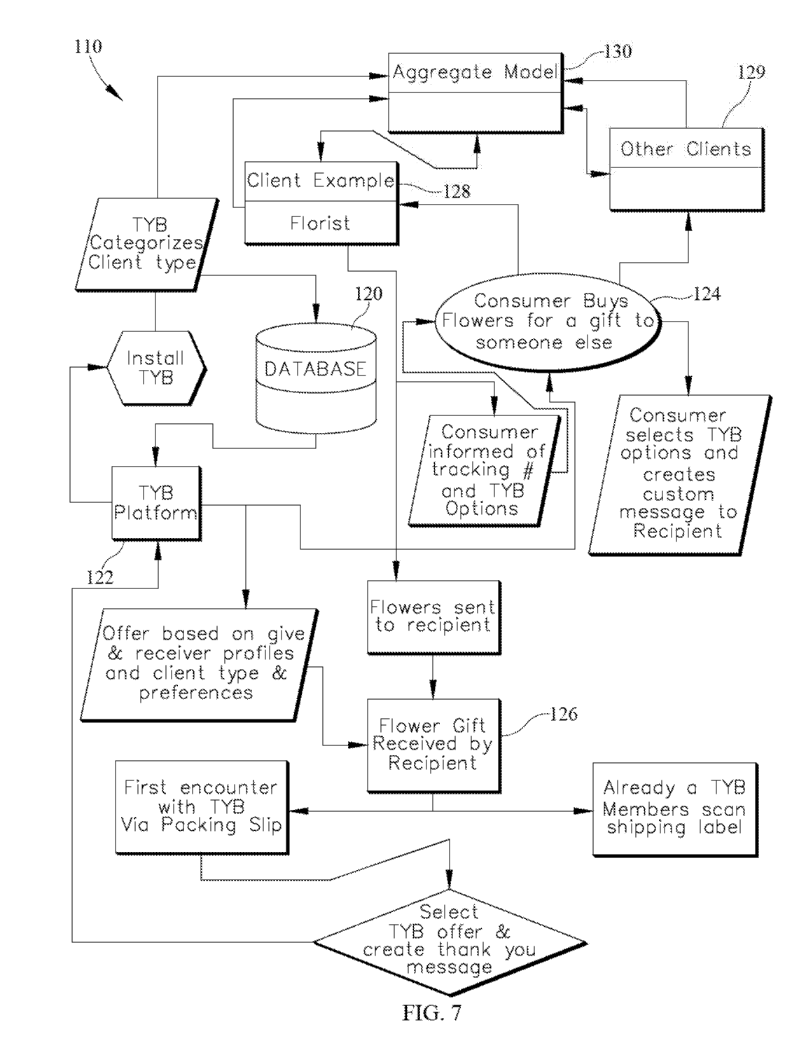

FIG. 7 shows another exemplary embodiment of a system 110 for obtaining information and approval to market to a recipient of a gift (from a giver), the gift including a unique identifier. The system 110 includes a database 120, a platform server 122, a gift giver communication device 124, and a gift recipient communication device 126. The system 110 also includes a merchant communication device 128, communication devices for other merchants (collectively) 129, and an aggregator service communication device 130. In this exemplary embodiment, the platform server 122 coordinates with the aggregator service communication device 130 (e.g., FedEx or an online marketplace such as sears.com) in such a way that all merchants that utilize the services of the aggregator can utilize the platform server 122 without having to do costly, individual integrations. In the examples, the merchants can “piggy back” on the existing infrastructure for communications between the aggregator service communication device 130 and the platform server 122. Incentives can be influenced by the buyer and recipient's profiles derived from previous purchases/recipients of goods and services from a multitude of merchants. The platform server 122 is consolidated to a singular installation/API with the aggregator service communication device 130. The aggregator service communication device 130 then incorporates the functionality and services of the platform server 122 in to its existing API, installations, and other connections with its merchants. The aggregator model allows for rapid and immediate growth of the functionality and services of the platform server 122.

It is noted that these tools of the above-described embodiments can also be used by brick-and-mortar retailers. A code can be added to the sales receipt (preferred embodiment). This code would essentially do the same thing as the code on a packing slip sent from an internet retailer.

It is also noted that the above-described embodiments reverse the marketing appeal from box stuffers that target rewards for the gift recipient to communications which targets a reward for the gift giver where the trigger for that reward is in the hands of the gift recipient.

### 3. Third Embodiment

### Sound Affections

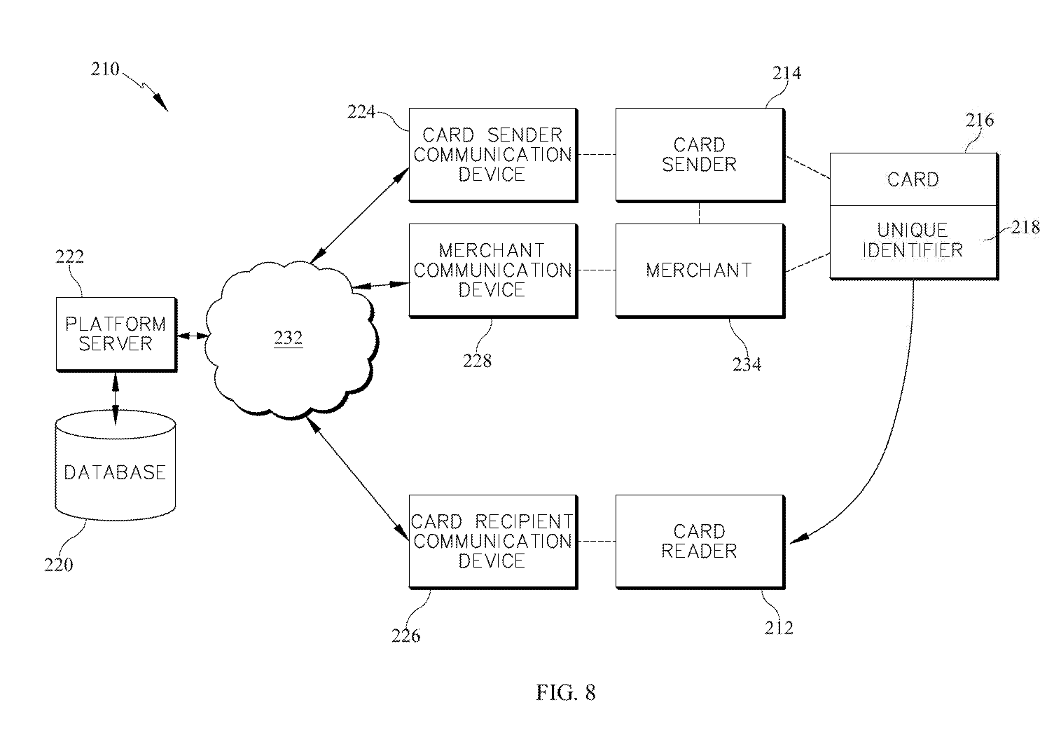

FIG. 8 shows another exemplary embodiment of a system 210 for obtaining information and approval to market to a recipient 212 of a gift (from a giver) including a unique identifier 218. However, in this instance the gift is a card 216 (e.g., a greeting card, a thank you card, an invitation, or other stationary) and the giver is a sender 214. The system 210 includes a database 220, a platform server 222, a card sender communication device 224, and a card recipient communication device 226. The system 210 may also include a merchant communication device 228.

A communication network 232 allows communication between the platform server 222, the card sender communication device 224, and the card recipient communication device 226. The communication network 232 may be the Internet, or any other appropriate network or networks for communicating information between the database 220, the platform server 222, and the communication devices 224, 226, 228 (i.e., computing and communicating machines and entities) discussed herein.

Also shown in FIG. 8 is a merchant 234. The merchant 234 is an entity, similar to the card recipient 212 and the card sender 214.

The platform server 222 is in communication with the database 220. The platform server 222 includes at least one processor operably connected to memory and input/output devices (not shown). The platform server 222 executes software, as discussed below. The platform server 222 may include more than one physical server and may also utilize “cloud hosting” or “managed hosting” (many servers hosted by third parties).

The card sender communication device 224 is in communication with the platform server 222 through the communication network 232. The card sender communication device 224 may be a personal computer, a tablet computer, a smart phone, or any other communication device capable of communicating with the platform server 222 through the communication network 232. The communication network 232 may be the Internet, or any other appropriate network or networks for communicating information between the computing and communicating machines discussed herein.

The card recipient communication device 226 is in communication with the platform server 222 through the communication network 232. The card recipient communication device 226 may also be a personal computer, a tablet computer, a smart phone, or any other communication device capable of communicating with the platform server 222 through the communication network 232.

The merchant communication device 228 of this exemplary embodiment may be a computer server or the like that hosts a website through which the merchant 234 offers and sells cards (i.e., an online merchant), or may be a personal computer, a tablet computer, a smart phone, or any other communication device with which a brick-and-mortar retailer can communicate with the platform server 222 through the communication network 232. Examples of online merchants of this exemplary embodiment include retailers such as Amazon.com and 1-800-Flowers.

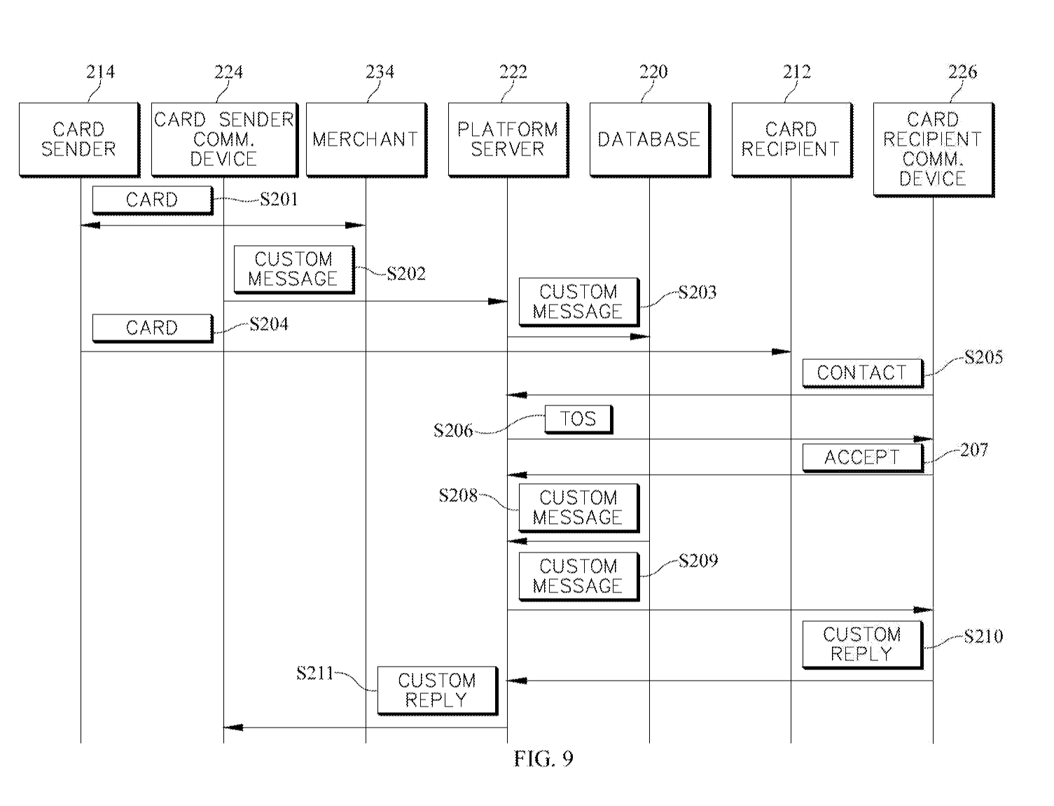

FIG. 9 is a call flow diagram showing exemplary interaction between the various computing and communicating machines and entities described herein, which are labeled in accordance with the labels shown in FIG. 8 and described in connection therewith.

In step S201, the card sender 214 purchases the card 216 from the merchant 234. The merchant 234 may be a brick-and-mortar store or may be an online retailer (and may even be the operator of the platform server 222). The unique identifier 218 identifies the merchant 234 from whom the card 216 was purchased, for credit allocation and other purposes. As mentioned above, the card 216 can be a greeting card, a thank you card, an invitation, or other stationery. The term “other stationary” includes an insert to a traditional greeting card or the like, which can transform any ordinary card or anything mailed into a vehicle for delivering custom messages. Each card 216 includes information (i.e., is “serialized”) for the card sender 214 to access the platform server 222 to create a custom message to the card recipient 212, to associate the custom message with the unique identifier 218, and for the card recipient 212 to access the platform server 222 to retrieve the custom message. The information allows the platform server 222 to know if a party is a card sender 214 or a card recipient 212. For example, the card 216 includes, for the card recipient 212 to access the platform server 222 via the card recipient communication device 226, a unique recipient URL (e.g., (www.platformserver/recipientuniqueidentifier)) or a unique recipient code/phone number (e.g., “text this code to this (XXX) XXX-XXXX”), or a unique recipient code for use with a non-unique URL or a non-unique code/phone number.

A card 216 purchased at a brick-and-mortar store may include, for the card sender 214 to access the platform server 222 via the card sender communication device 224, a unique sender URL (e.g., (www.platformserver/senderuniqueidentifier)) or a unique sender code/phone number (e.g., “text this code to this (XXX) XXX-XXXX”), or a unique sender code for use with a non-unique URL or a non-unique code/phone number. An insert may include a sender code good for a certain number of uses where the platform server provides a unique recipient code that the card sender 214 writes on each respective card 216 so each respective card recipient 212 can retrieve the custom message.

When the merchant 234 is an online retailer, the custom message (described below) will automatically be associated with the unique identifier 218. The online retailer can also provide the card sender 214 with various options for the card 216, such as font options, custom templates for different occasions, uploading and cropping images/photos, editing captions, custom messages, and spell checking. The online retailer can also provide the card sender 214 with the option of mailing the card directly or sending the card 216 to the card sender 214 for mailing.

In step S202, the card sender 214 provides sender contact information and selects, using the card sender communication device 224 in communication with the platform server 222, from several options to create a custom message to the card recipient 212. The platform server 222 does not share the sender contact information with the card recipient 212. The options include video, text, voice, or picture with caption. The card sender communication device 224 may be a personal computer, a tablet computer, a smart phone, or any other communication device capable of communicating with the platform server 222 through the communication network 232. The platform server 222 can allow the card sender 214 to password protect the custom message, and provide the password to the card recipient 212 by their own means. Included in step S202 is the card sender 214 accepting, using the card sender communication device, a terms of service (“TOS”) presented by the platform server 222, including approval for receiving marketing from the merchant 234 or another party.

In step S203, the platform server 222 associates the sender contact information and the custom message to the unique identifier and saves the sender contact information and the custom message to the database 220.

In step S204, the card 216 is mailed to the card recipient 212 by either the card sender 214 or the merchant 234.

In step S205, after receiving the card 216, the card recipient 212, using the card recipient communication device 226 and the unique information, contacts the platform server 222. If the card recipient 212 has not previously accepted a TOS, step S206 is sending the TOS to the card recipient communication device 226. This step includes reassurance to the card recipient 212 that the contact information of the recipient 212 will not be shared with the card sender 214. Then step S207 is sending an indication of acceptance of the TOS from the card recipient communication device 226 to the platform server 222. Acceptance of the TOS includes receiving from the card recipient communication device 226 a sign on through social media or creating a user name and a password. Additional contact information, such as an email address, and a phone number may also be part of acceptance of the TOS. Acceptance of the TOS also includes approval for receiving marketing from the merchant 234 or another party.

Upon acceptance of the TOS, or, if the TOS was previously accepted, step S208 is the platform server 222 retrieving the custom message from the database 220, and step S209 is delivering the custom message to the gift recipient communication device 226.

In step S210, the card recipient 212 selects, using the card recipient communication device 226 in communication with the platform server 222, from several options to create a custom reply message to the card sender 214. The options include video, text, voice, or picture with caption. The platform server 222 does not share the card recipient contact information with the card sender 214. The platform server 222 can allow the card recipient 212 to password protect the custom reply message, and provide the password to the card sender 214 by their own means. In the event that the card 216 is an invitation, the custom reply message is a reply to the invitation (i.e., an RSVP). The invitation can include questions, and the reply can include answers to the questions, and the platform server 222 can create a real time spreadsheet sortable by who is confirmed (plus guests), who is not coming, and who has not responded, as well as who is bringing what.

In step S211, the platform server 222 communicates the custom reply message to the card sender communication device 224.

After a predetermined number of free views (e.g., one or two) to the card recipient 212 and the card sender 214, the platform server 222 can lock out future messages until each message maker provides a credit card so the operator of the platform server 222 can bill for each message beyond that. Conversely they can elect free use and be exposed to ads that allow monetization

Advantageously, after the first use of cards purchased in a brick and mortar store, or their first encounter with the platform server 222 online, the users can be offered to create new, update, edit and repeat cards on an anniversary of their creation. They can also choose paperless for contacts that the platform server 222 has collected or that they added. They can also choose that the operator of the platform server 222 would send the physical card for them though the sender 214 never possessed them, they are still very personalized with their words, voice and images.

In packages of cards, each package of cards has an instruction sheet and the sheet includes a unique code for that package of cards. Once that code is entered by the first user, they are asked to provide their email address. Only that email address is given rights to make/use the cards in that deck. If another user somehow guesses at a code, they would need to know the exact email address for that code to continue. Further, each card is preprinted with a letter followed by two numbers and a blank following that. The two preprinted numbers on each card represent the range of that card pack. A six pack of cards would be preprinted with 00 through 05. As recipients key in the code the platform server tracks the card's usage and stops the card pack purchaser from creating new messages once all six cards have been received/used by the recipients. The preprinted letter on each card indicates the type of the card (thank you, Christmas, birthday; etc.). If a recipient receives a card with just the preprinted letter followed by two numbers, they will think that is the complete code and enter it at the platform server. The platform server recognizes the card sender's mistake and the intended occasion and plays a prerecorded, non-personalized message germane to the card occasion. Further, each card can only be accessed a predetermined number of times (e.g., two) and then the recipient is forced to downloaded it locally to their device, allowing them to replay it without additional cost to the platform server. Lastly, the submit button will only become active when a valid code is entered.

### 4. Fourth Embodiment

### Retentage

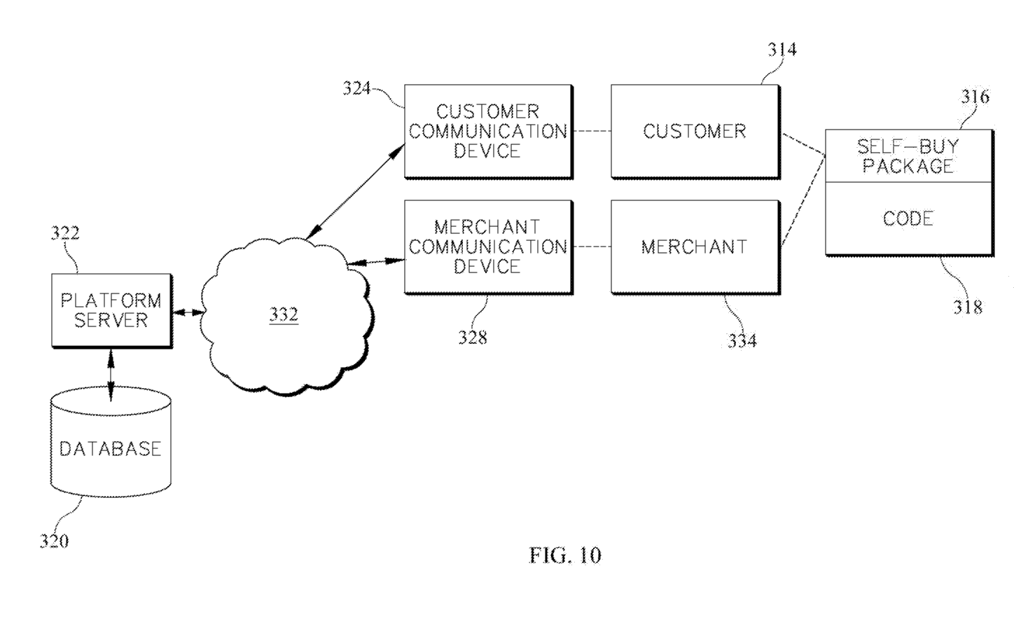

FIG. 10 shows an exemplary embodiment of a system 310 for obtaining information and approval to market to a purchaser (i.e., a customer 314) of a package 316 including a code 218 printed on a card or other document included with the package. The system 310 includes a database 320, a platform server 322, a customer communication device 324, and a merchant communication device 328.

A communication network 332 allows communication between the platform server 322, the customer communication device 324, and the merchant communication device 328. The communication network 332 may be the Internet, or any other appropriate network or networks for communicating information between the database 320, the platform server 322, and the communication devices 324, 328 (i.e., computing and communicating machines and entities) discussed herein.

Also shown in FIG. 10 is a merchant 334. The merchant 334 is an entity, similar to the customer 314.

The platform server 333 is in communication with the database 320. The platform server 322 includes at least one processor operably connected to memory and input/output devices (not shown). The platform server 322 executes software, as discussed below. The platform server 322 may include more than one physical server and may also utilize “cloud hosting” or “managed hosting” (many servers hosted by third parties).

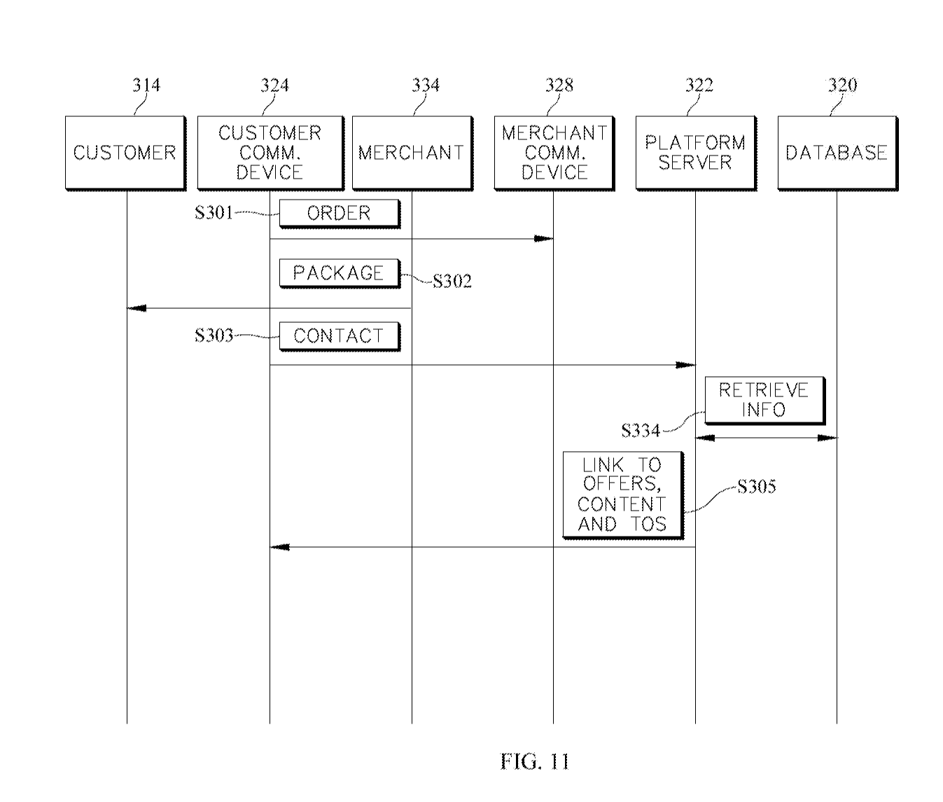

FIG. 11 is a chart showing exemplary interaction between the various computing and communicating machines and entities described herein, which are labeled in accordance with the labels shown in FIG. 10 and described in connection therewith.

In step S301, the customer 314 places an order with the merchant 334 for the self-buy package 16. For example, the step could be the customer 314 ordering a package using a web site (i.e., an online merchant) or at a brick-and-mortar store. FIG. 11 shows the customer 314 placing the order using the customer communication device 324 in communication with the merchant communication device 328. As used herein, the customer communication device 324 could include a combination of communication devices (e.g., personal computer, a tablet computer, a smart phone, or any other communication device capable of communicating with the platform server 22 through the communication network 32), such that the customer 314 could place an order using one device (e.g., a computer) and could receive a message (discussed below) from the merchant 334 using another device (e.g., a smart phone).

In step S302, the self-buy package 316 is send from the merchant 334 to the customer along with an insert or other document including a code 318, such as a URL and/or a code/phone number 49 (e.g., “text this code to this (xxx) XXX-XXXX”) for the customer 314 to use to contact the platform server 322 (discussed below). The code/text number is the preferred method due to its ease. The code 318 can be a unique code for the self-buy package, or it can be a general code for the merchant 334. A unique code allows the merchant 334 to address the customer 314 by name and their shopping habits captured, since the unique code would be linked to a unique order number at time of checkout. The shopping habits will be useful for the merchant 334 so that it can select more targeted promotions to the customer 314.

In step S303, the customer 314, using the customer communication device 324, contacts the platform server 322 using the code 318 included with the self-buy package 316.

In step S304, the platform server 322 retrieves information associated with the customer 314 from the database 20 to determine if the customer 314 has accepted terms of service (TOS) previously.

In step S305, the platform server 322 sends the customer communication device 324 a link to a URL containing an incentive (e.g., offers and content), and, if not previously accepted, the TOS.

Engagement starts with a brief written message from the merchant 334. The message calls out the customer 314 by name. The personalized message is typed including the name of customer for online retailer but in the case of brick and mortar customer paying by cash the retailer's employee would ask the name of consumer and write it into a blank on an otherwise preprinted card. This intro message will “know” if this is the consumer's first or return visit (welcome back) to this page on behalf of the client—a nice touch. The platform server 322/database 320 confirms if this number/person is returning to this merchant 334 (could be a repeat channel user but arriving at this merchant 334 via the platform server for the first time. After this intro the merchant 334 can provide additional content via audio, video or more text. This content can be coupons and loyalty programs, etc. The platform server 322 asks the customer 314 for how they should get that content (email or text) and get TOS approval. The page the customer 314 is brought to should contain content that is engaging and that motivates the customer 314 to accept TOS via promotions; etc. The page should also allow responses by the customer 314 by selecting between predefined categories that the merchant 334 may select from including: Register your product; contact CS, claim a coupon or gift, buy a voucher. The merchant 334 can add its own promotion which may and should be linked to the code 318 to manage sign in by social media.

The fact that no advanced knowledge of the cell phone or email is needed to work also makes possible new marketing methods for the merchant 334 (either on and offline) during non-gift, self-buy purchases. It can replace the expensive, yet low performing box stuffers with individualized offers. The message is triggered by the code 318, used by the customer 314, to “opt in” for offers immediately brought to them by text or email. As the customer 314 buys more thanks to these special promotions (greater discounts made possible by the removing of printed materials in every box), the merchant 334 gains insight into the buying habits of the customer 314 and individually customizes and optimizes (i.e., personalizes) the offers for the customer 314.

### 4. Additional Embodiments

One of ordinary skill in the art will recognize that additional embodiments are possible without departing from the teachings of the invention. This detailed description, and particularly the specific details of the exemplary embodiments disclosed, is given primarily for clearness of understanding and no unnecessary limitations are to be understood therefrom, for modifications will become evident to those skilled in the art upon reading this disclosure and may be made without departing from the spirit or scope of the claimed invention.

What is claimed is:

1. A system for obtaining information and approval to market to a recipient of a gift, the system comprising:
a database; and
a platform server in communication with the database, the platform server including a processor operably connected to memory, and input/output devices;
the processor executing software instructions stored in the memory for causing the platform server to:
store in the database a unique identifier and order information including contact information of a giver and contact information of the recipient; and
send a thank you message to a gift giver communication device in response to receiving a request from a gift recipient communication device, verification from the gift recipient communication device using the unique identifier, and approval from the gift recipient communication device for receiving marketing from a merchant.

2. The system of claim 1, wherein the platform server associates a custom message to the recipient with the unique identifier in response to receiving a selection from the gift giver communication device of an option to create the custom message, and delivers the custom message to the gift recipient communication device in response to the verification.

3. The system of claim 1, wherein the gift includes an incentive for the recipient to thank the giver, and wherein the platform server associates the incentive with the unique identifier, and releases and sends the incentive to the giver with the thank you message, so that release of the incentive is controlled by the recipient.

4. The system of claim 1, wherein the platform server manages generation of a physical thank you card with a custom message to be sent by mail to the giver in response to a request from the gift recipient communication device.

5. The system of claim 1, wherein the platform server manages purchase and sending of a gift card by the recipient to the giver in response to a request from the gift recipient communication device.

6. The system of claim 1, wherein verification from the gift recipient communication device using the unique identifier utilizes a URL hosted by the platform server.

7. The system of claim 1, wherein the unique identifier is included on an internal packing slip of the gift.

8. The system of claim 1, wherein the unique identifier is included on a shipping label of the gift.

9. A method for obtaining information and approval to market to a recipient of a gift, the method comprising:
storing in a database, by a platform server, a unique identifier, order information, contact information of a giver, and contact information of the recipient; and
sending, by the platform server, a thank you message to a gift giver communication device in response to receiving a request from a gift recipient communication device, verification from the gift recipient communication device using the unique identifier, and approval from the gift recipient communication device for receiving marketing from a merchant.

10. The method of claim 9, further comprising associating, by the platform server, a custom message to the recipient with the unique identifier in response to receiving a selection from the gift giver communication device of an option to create the custom message, and delivering the custom message to the gift recipient communication device in response to the verification.

11. The method of claim 10, further comprising associating, by the platform server, the custom message with the unique identifier before shipment of the gift.

12. The method of claim 10, further comprising associating, by the platform server, the custom message with the unique identifier during transit of the gift.

13. The method of claim 9, further comprising sending, by the platform server, a reassurance message to the gift recipient communication device that contact information of the recipient will not be shared with the giver, and receiving acceptance of terms of service from the gift recipient communication device before sending the thank you message.

14. The method of claim 13, wherein acceptance of the terms of service includes receiving from the gift recipient communication device a sign on through social media or creating a user name and password.

15. The method of claim 9, further comprising managing, by the platform server, generation of a physical thank you card with a custom message to be sent by mail to the giver in response to a request from the gift recipient communication device.

16. The method of claim 9, further comprising managing, by the platform server, purchase and sending of a gift card by the recipient to the giver in response to a request from the gift recipient communication device.

17. A system for obtaining information and approval to market to a recipient of a card, the system comprising:
a database; and
a platform server in communication with the database, the platform server including a processor operably connected to memory, and input/output devices;
the processor executing software instructions stored in the memory for causing the platform server to:
store in the database a unique identifier, contact information of a card sender, and a custom message to the recipient from a card sender communication device; and
send the custom message to a card recipient communication device in response to receiving verification from the card recipient communication device using the unique identifier, and approval from the card recipient communication device for receiving marketing from a merchant.

18. The system of claim 17, wherein the platform server further sends a custom reply to the card sender communication device in response to receiving the custom reply from the card recipient communication device.

19. The system of claim 18, wherein the card is an invitation, and wherein the custom reply is a reply to the invitation.

20. The system of claim 19, wherein the invitation includes questions, and wherein the custom reply includes answers to the questions.

21. The system of claim 19, wherein the platform server creates a spreadsheet sortable by who is confirmed, who is not coming, and who has not responded.

22. A method for obtaining information and approval to market to a recipient of a card, the method comprising:
storing in a database, by a platform server, a unique identifier, contact information of a card sender, and a custom message to the recipient from a card sender communication device; and
sending, by the platform server, the custom message to a card recipient communication device in response to receiving verification from the card recipient communication device using the unique identifier, and approval from the card recipient communication device for receiving marketing from a merchant.

23. The method of claim 22, further comprising sending, by the platform server, a reassurance message to the card recipient communication device that contact information of the card recipient will not be shared with the card sender, and receiving acceptance of terms of service from the card recipient communication device before sending the custom message.

24. The method of claim 23, wherein acceptance of the terms of service includes receiving from the card recipient communication device a sign on through social media or creating a user name and password.

25. A system for obtaining information and approval to market to a customer receiving a package, the system comprising:
a database; and
a platform server in communication with the database, the platform server including a processor operably connected to memory, and input/output devices;
the processor executing software instructions stored in the memory for causing the platform server to:
store in the database an identifier and a link to a URL containing an incentive from a merchant; and
send the link to a customer communication device in response to receiving verification from the customer communication device using the identifier, and approval from the customer communication device for receiving marketing from the merchant.

26. The system of claim 25, wherein the identifier is a unique identifier, wherein identification of the customer is associated with the unique identifier in the database, and wherein the incentive from the merchant is personalized for the customer.

27. A method for obtaining information and approval to market to a customer receiving a package, the method comprising:
storing in a database, by a platform server, an identifier and a link to a URL containing an incentive from a merchant; and
sending, by the platform server, the link to a customer communication device in response to receiving verification from the customer communication device using the identifier, and approval from the customer communication device for receiving marketing from the merchant.

28. The method of claim 27, wherein the identifier is a unique identifier, wherein identification of the customer is associated with the unique identifier in the database, the method further comprising personalizing the incentive from the merchant for the customer.
